(19) United States
(12) Patent Application Publication
(10) Pub. No.: US 2008/0268763 A1
(43) Pub. Date: Oct. 30, 2008

(54) Vent flap

(75) Inventor: Thomas Dippel, Neuhemsbach (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Electronics & Components GmbH

(21) Appl. No.: 12/148,814

(22) Filed: Apr. 23, 2008

(30) Foreign Application Priority Data
Apr. 26, 2007 (DE) 202007006724.0

(51) Int. Cl. B60H 1/34

(52) U.S. Cl. 454/152

(57) ABSTRACT

A vent flap, in particular for venting an interior of a vehicle, includes a frame (12) consisting of a first material and at least one non-return flap (18). The frame (12) has a continuously surrounding spring member (20) which is formed on the frame (12) and includes, at least in partial regions, a seal (24) made of a second material.

### BACKGROUND OF THE INVENTION

Such a vent flap allows the air supplied to the vehicle interior by means of a ventilation system to be carried off. If no air flows out of the vehicle interior, the non-return flap rests against the frame, so that any penetration of moisture, exhaust gas or dirt into the interior is prevented. It is known to produce vent flaps of this type in a two-component injection-molding process, the frame consisting of a hard material component, whereas the non-return flap is formed of a softer material component. To fasten the vent flap in an opening of the body of the vehicle, the frame normally has a plurality of fastening members and a seal fitted on its side facing the vehicle body, the seal usually being foamed or likewise injection-molded from a soft material component. The seal has an influence on the force required for inserting the vent flap into the opening of the vehicle body since it must be compressed during assembly. In the case of a foamed seal, the mounting force is dictated by the type of foam used and can only be changed by the use of a new foam mixture. In the case of a soft material component joined by injection-molding, the flexibility of the material and the design of the seal determine the mounting force and the tightness of the system. In addition, the soft material component needs to exhibit a certain capability of recovery in order that a reliable sealing effect is ensured.

Compared with this, the present invention provides a vent flap which stands out by a particularly simple and low-cost manufacture and by providing a reliable sealing from a carrier part.

### BRIEF SUMMARY OF THE INVENTION

This is achieved in a vent flap, in particular for venting an interior of a vehicle, includes a frame consisting of a first material and at least one non-return flap. The frame has a continuously surrounding spring member which is formed on the frame and includes, at least in partial regions, a seal made of a second material. In this arrangement, in the fitted condition the spring member lies at least partially against a carrier part of the vehicle, the seal being provided on the side of the spring member facing the carrier part. The configuration according to the invention allows the proportion of the soft component, from which the seal is preferably shaped, to be reduced to a minimum. The spring member itself is produced from a harder material component and is designed in such a way that it applies a force onto the seal which presses the latter firmly against the carrier part of the vehicle. For this reason, it is not necessary for the material used for the seal to exhibit a capability of recovery itself.

Preferably, the spring member is likewise made of the first material; more specifically, it is formed in one piece with the frame. In this way, the spring member and the frame can be manufactured in a single processing step.

So as to attain a particularly good sealing effect, the spring member may, in the initial condition prior to installation, include an acute angle with the plane defined by the frame. In the installed condition, this angle decreases and the spring member exerts a comparatively great force on the seal because of it being prestressed.

The seal is preferably arranged so as to run all around the periphery in an edge region of the spring member and thus provides for a reliable sealing action between the vent flap and the carrier part of the vehicle.

In order to allow the force exerted on the seal by the spring member as well as the mounting force to be adjusted as required, the spring member may include a plurality of recesses.

Preferably, the recesses are arranged all around the periphery near the region of transition to the frame; in this way, they have an influence on the deformability of the spring member in relation to the frame.

To obtain a closed sealing system, the recesses are preferably closed off by the material of the seal.

The vent flap is more specifically a multi-component injection-molded part, the frame and the spring member being produced from a hard material component and the non-return flap and the seal being each produced from a soft material component. This results in a so-called “off-tool” part, i.e. an assembly or a second operation are not required. In particular, the flap(s) and the seal are injection-molded from the same material component in one single operating cycle; as an alternative, however, it is also possible for two different materials to be used. It is further conceivable to subsequently install one or more flaps into the injection-molded frame with the spring member and the seal.

### BRIEF DESCRIPTION OF THE DRAWINGS

FIG. 1 shows a perspective view of a vent flap according to the invention;

FIG. 2 shows a section along the line II-II in FIG. 1; and

FIG. 3 shows a section along the line III-III in FIG. 1.

### BRIEF DESCRIPTION OF THE PREFERRED EMBODIMENT

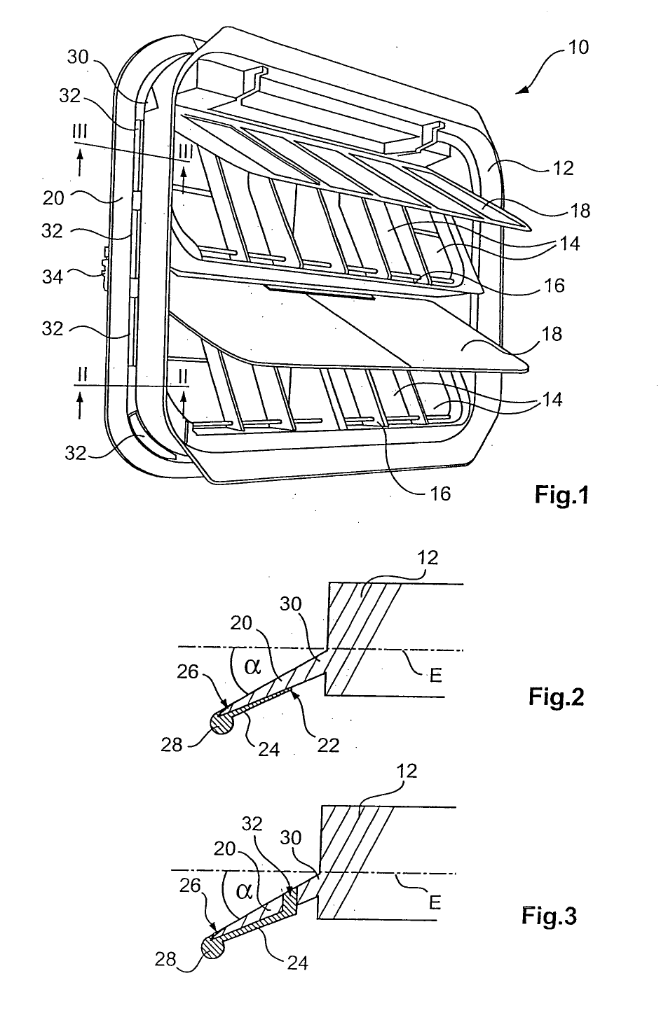

FIG. 1 shows a vent flap 10 which can be inserted into an opening in a carrier part of a vehicle and has a frame 12 made of a first, hard plastic material. The frame 12 has the shape of a grid and includes a plurality of outflow openings 14. The grid-like structure results in the formation of two valve seats 16, arranged one above the other with respect to the illustration in FIG. 1, which are arranged inclined in relation to the plane defined by the frame 12. Assigned to each valve seat 16 is a non-return flap 18 made of a second, softer plastic material, both non-return flaps 18 being shown in the open condition in FIG. 1.

A surrounding spring member 20 is formed on the frame 12, the spring member 20 being formed in one piece with the frame 12 and is thus likewise made of the first material, i.e. the harder plastic material. As is more particularly also apparent from FIGS. 2 and 3, the spring member 20 includes an acute angle a with the plane E defined by the frame 12, at least in the initial condition prior to installation of the vent flap 10. Provided on the face 22 of the spring member 20 facing the carrier part (that is, the lower side of the spring member 20 as shown in the illustration in FIGS. 2 and 3) is a seal 24 which is also made of the second, soft plastic material and is, more particularly, joined to the spring member 20 by injection-molding. The seal 24 is arranged so as to surround the entire frame 12 in an edge region 26 of the spring member 20 and has a bead 28 of material on the outer edge of the spring member 20. Close to the region 30 of transition to the frame 12, the spring member 20 has a plurality of recesses 32 arranged all around the periphery at certain distances from one another. As can be seen in FIG. 3, the recesses 32 are closed off by the material of the seal 24.

Furthermore, to attach the vent flap 10 to the carrier part of the vehicle, provision is made for a plurality of attachment tabs 34 which are formed in one piece with the frame 12 and one of which is indicated in FIG. 1.

The vent flap 10 is a multi-component injection-molded part, the frame 12 and the spring member 20 being molded from the first, hard material component in a first step, and the non-return flaps 18 and the seal 24 made of the second, soft material component then being joined by molding. As an alternative, the flaps can also be mounted later.

For mounting the vent flap 10 in the carrier part, the vent flap is pushed into an opening of the carrier part, with the face 22 of the spring member 20 first, whereby, compared with the illustration in FIGS. 2 and 3, the spring member 20 is bent slightly upwards until the attachment tabs 34 engage behind the opening in the carrier part. An appropriate configuration of the recesses 32 allows the force necessary for insertion to be adjusted practically as desired. In its mounted condition, the spring member 20 is prestressed, as a result of which the seal 24 is pressed against the carrier part to thus provide for a reliable sealing effect.

1. A vent flap, in particular for venting an interior of a vehicle, comprising
a frame (12) consisting of a first material and
at least one non-return flap (18),
said frame (12) having a continuously surrounding spring member (20) which is formed on said frame (12) and includes, at least in partial regions, a seal (24) made of a second material.

2. The vent flap according to claim 1, wherein said spring member (20) likewise consists of the first material, more particularly is formed in one piece with said frame (12).

3. The vent flap according to claim 1, wherein said frame (12) defines a plane (E), in an initial condition prior to installation, said spring member (20) including an acute angle (a) with said plane (E) defined by said frame (12).

4. The vent flap according to claim 1, wherein said spring member (20) comprises an edge region (26), said seal (24) being arranged to run all around the periphery in said edge region (26) of said spring member (20).

5. The vent flap according to claim 1, wherein said spring member (20) includes a plurality of recesses (32).

6. The vent flap according to claim 5, wherein said recesses (32) are arranged all around the periphery near a region (30) of transition to said frame (12).

7. The vent flap according to claim 5, wherein said recesses (32) are closed off by the material of said seal (24).

8. The vent flap according to claim 1, wherein it is a multi-component injection-molded part, said frame (12) and said spring member (20) being produced from a hard material component and said non-return flap (18) and said seal (24) being each produced from a soft material component.
